(19) United States
(12) Patent Application Publication
(10) Pub. No.: US 2014/0078270 A1
(43) Pub. Date: Mar. 20, 2014

(54) LOCAL STEREO IMAGE DISPLAY SYSTEM, LOCAL STEREO IMAGE DISPLAY METHOD AND ADJUSTING METHOD THEREOF

(71) Applicant: HannStar Display Corp., New Taipei City (TW)

(72) Inventors: Wen-Zhe LIN, Tainan City (TW); Chih-Husan LEE, Tainan City (TW); Chun-Chin TSENG, Kaohsiung City (TW)

(73) Assignee: HannStar Display Corp., New Taipei City (TW)

(21) Appl. No.: 14/030,935

(22) Filed: Sep. 18, 2013

(30) Foreign Application Priority Data
Sep. 19, 2012 (CN) 201210350228.4

(51) Int. Cl. H04N 13/04; G02B 27/22

(52) U.S. Cl. CPC H04N 13/0486; G02B 27/22
USPC 348/55

(57) ABSTRACT

A local stereo image display system controls an image output in a display area which includes a planar image frame and a stereo image frame. The planar image frame has a planar image region. The stereo image frame is disposed between two adjacent planar image frames and has a stereo image region. The planar image frame and the stereo image frame are outputted orderly with a display frequency. When the planar image frame is outputted, only the planar image region has image content, and when the stereo image frame is outputted, only the stereo image region has image content. An optical grating control signal is outputted according to the sequence of the planar image frame and the stereo image frame and is synchronized to the display frequency.

### BACKGROUND OF THE INVENTION

1. Field of the Invention

The present invention relates to an image display system. Particularly, the present invention relates to an image display system having a local stereo image display signal.

2. Description of the Prior Art

In recent years, the stereo image display technique gradually satisfies the public in the aspect of entertainment. As the demand for the stereo visual effect gradually increases, the stereo image display technique is applied to movies as well as other fields, such as televisions, desktop screens, and mobile handheld devices.

The stereo image display technique utilizes the disparity of human eyes to fuse different images so that people will be aware of the space impression. Traditionally, the display device that performs the stereo visual effect can be classified into two types: using special glasses and not using special glasses. Taking the stereo image display technique without using special glasses for example, it can be classified into the following two types: (a) disposing a polarizer at an outer side of a display panel to permit light of image generated by the display panel to locate at the positions of the right eye and the left eye in order; (b) directly disposing a splitter structure in a backlight module, so that light generated from the backlight module will deflect and develop images in the left eye and the right eye after passing the display panel.

However, the traditional stereo image display device can only provide the stereo visual effect in full screen and cannot generate the stereo image in a part of the planar image. In order to achieve the effect of displaying the planar image together with the stereo image, the applicant provides the present application mentioned as follows.

### SUMMARY OF THE INVENTION

It is an object of the present invention to provide a local image display system and a signal stream utilized thereof to present a planar image and a stereo image together.

A local stereo image display system includes a signal processing module, an optical grating switching controller, and an image display device. The signal processing module outputs a local stereo image display signal stream to the image display device by a frame outputting unit. The local stereo image display signal stream includes a planar image frame and a stereo image frame. The planar image frame and the stereo image frame are outputted alternatively with a display frequency. The optical grating switching controller outputs an optical grating control signal according to the sequence of the planar image frame and the stereo image frame and is synchronized to the display frequency to alternatively switch optical gratings to an active mode or an inactive mode. The image display device displays images according to the local stereo image display signal stream and the on/off state of optical gratings.

A local stereo image display method includes the following steps: outputting a planar image frame to an image display device and an optical grating switching controller; the optical grating switching controller outputting an optical grating control signal to an optical grating device to turn off a plurality of optical gratings; outputting a stereo image frame to the image display device and the optical grating switching controller; and the optical grating switching controller outputting another optical grating control signal to the optical grating device to turn on the plurality of optical gratings.

A local stereo image adjusting method includes the following steps: the touch receiving unit outputting a signal to a frame outputting unit according to a command outputted from a touch interface, and the frame outputting unit adjusting a planar image region and a stereo image region.

### BRIEF DESCRIPTION OF THE DRAWINGS

FIG. 1 is a schematic view of outputting a planar image frame and a stereo image frame;

FIG. 2 is a schematic view of a local stereo image;

FIG. 3 is a schematic view of generating a local stereo visual effect;

FIG. 4 is a schematic view of a local stereo image display system;

FIG. 5 is a schematic view of a local stereo image display device;

FIG. 6A is a schematic view of an embodiment of changing a specific area into a stereo image;

FIG. 6B is a schematic view of an embodiment of enlarging a specific area; and

FIG. 7 is a flowchart of a local stereo image display method.

### DETAILED DESCRIPTION OF THE PREFERRED EMBODIMENT

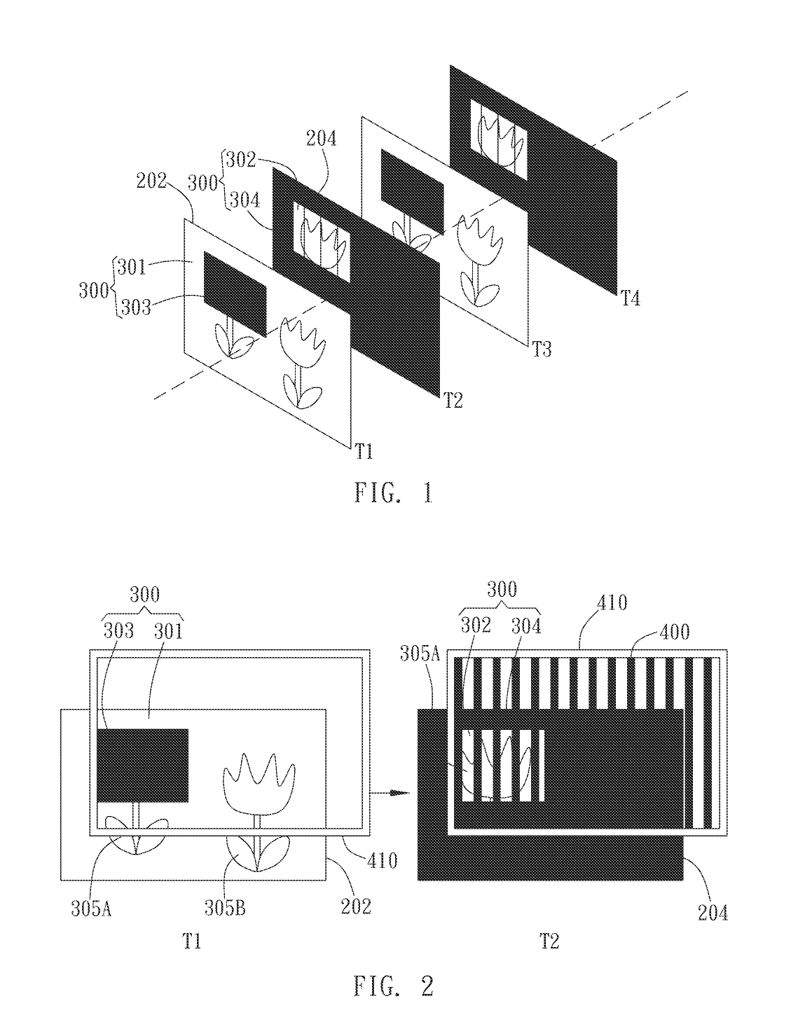

FIG. 1 is a schematic view of outputting a planar image frame 202 and a stereo image frame 204. As shown in FIG. 1, a local stereo image display signal stream, which includes a planar image frame 202 displayed at a first time (T1) and a stereo image frame 204 displayed at a second time (T2), controls the outputting of images in a display area 300. The planar image frame 202 has a planar image region 301 capable of displaying a two-dimensional image and has a first black image region 303. The stereo image frame 204 has a stereo image region 302 capable of displaying a three-dimensional image and has a second black image region 304. The stereo image frame 204 displayed at the second time (T2) is arranged between two adjacent planar image frames 202. That is, the stereo image frame 204 displayed at the second time (T2) is arranged between one planar image frame 202 displayed at the first time (T1) and the other planar image frame 202 displayed at a third time (T3), so that the planar image frame 202 and the stereo image frame 204 are displayed alternatively at T1, T2, T3, and T4 along the time axis. As shown in FIG. 1, in the planar image frame 202, only the planar image region 301 has image content while the first black image region 303 is black with a black image. In the stereo image frame 204, only the stereo image region 302 has image content while the second black image region 304 is black with a black image. The stereo image region 302 and the second black image region 304 correspond to the first black image region 303 and the planar image region 301 of the planar image frame 202, respectively.

Please further refer to FIG. 2; FIG. 2 is a schematic view of a local stereo image. As shown in FIG. 2, when the planar image frame 202 is outputted at the first time (T1), optical gratings 400 are turned off serving as a transparent layer to completely display the image of the planar image region 301 and the black image of the first black image region 303. When the stereo image frame 204 is outputted at the second time (T2), optical gratings 400 are turned on to display the image with stereo visual effect of the stereo image region 302 and the black image of the second black image region 304.

It is noted that, in this embodiment, optical gratings 400 are arranged at regular intervals across the whole frame, instead of being locally arranged. However, in other embodiments, optical gratings 400 may be locally disposed corresponding to the position of the stereo image region 302. When the position and the size of the stereo image region 302 in the stereo image frame 204 are adjusted, optical gratings 400 can accordingly present the stereo visual effect. In other embodiments, the display area 300 may include a number of stereo image regions 302, and optical gratings 400 are turned on to enable a plurality of stereo image regions 302 to display the stereo visual effect.

The stereo image region 302 and the planar image region 301 in the display area 300 are not the same. As shown in FIG. 2, the planar image region 301 displayed by the planar image frame 202 at the first time (T1) and the stereo image region 302 displayed by the stereo image frame 204 at the second time (T2) are complementary, and images in the planar image frame 202 and the stereo image frame 204 are also complementary. In other embodiments, a number of the stereo image regions 302 in different size may be outputted to the displayed area 300, and the planar image region 301 is displayed in the rest of the displayed area 300. User can watch the local stereo image of an object 305A together with images of the planar image frame 202 that are outputted previously and include a part of the planar image of the object 305A and the planar image of the object 305B when the planar image frame 202 and the stereo image frame 204 are orderly outputted with a display frequency preferably larger than or equal to 120 Hz (i.e. 1/(T2−T1)≧120 Hz, the measurement unit of T1 and T2 is second), and optical gratings are simultaneously turned on/off based on the display frequency.

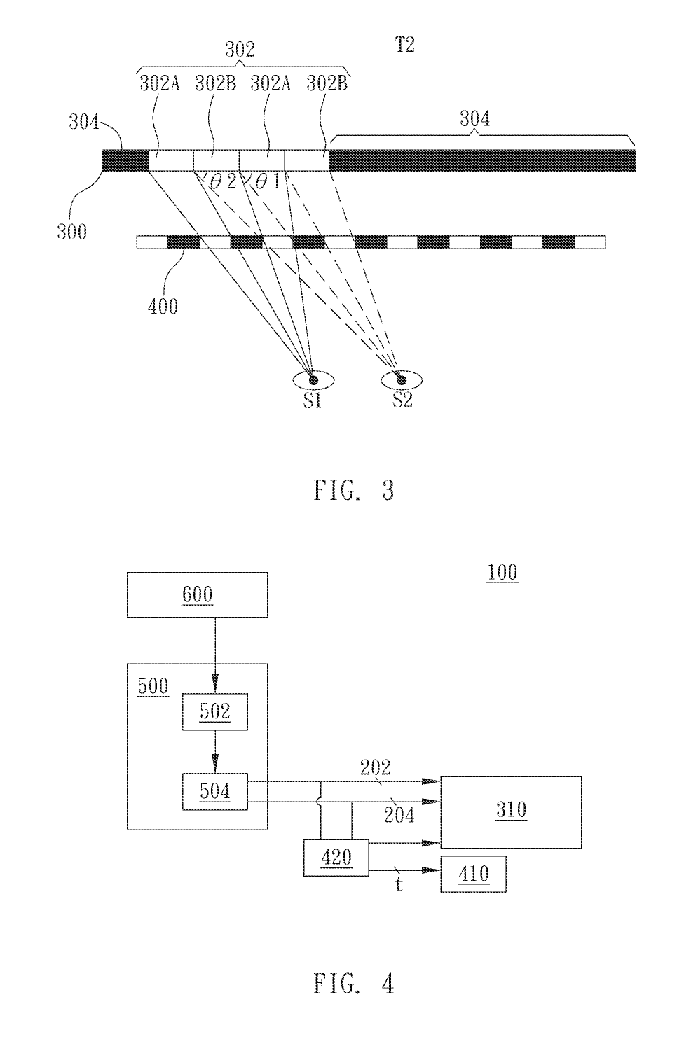

FIG. 3 is a schematic view of generating a local stereo visual effect. As shown in FIG. 3, the display area 300 displays the second black image region 304 and the stereo image region 302 at the second time (T2). The stereo image region 302 further includes a plurality of odd column images 302A and a plurality of even column images 302B interlaced to each other. A plurality of optical gratings 400 is disposed at the display side of the display area 300. At the second time (T2), optical gratings 400 are simultaneously activated to allow the odd column images 302A to reach the first eye (S1) and the even column images 302B to reach the second eye (S2). As shown in FIG. 3, because optical gratings 400 shield some angle of light emitted from the odd column images 302A, light emitted from the odd column images 302A will pass through spaces between two optical gratings to the first eye (S1) at a first predetermined angle θ1. Similarly, optical gratings 400 also shield some angle of light emitted from the even column images 302B, so that light emitted from the even column images 302B will pass through spaces between two optical gratings to the second eye (S2) at a second predetermined angle θ2. Therefore, the user can observe, without wearing 3D glasses, the stereo image at the local position by means of the optical gratings 400 which block light at specific positions to allow light selectively to reach the first eye (S1) or the second eye (S2).

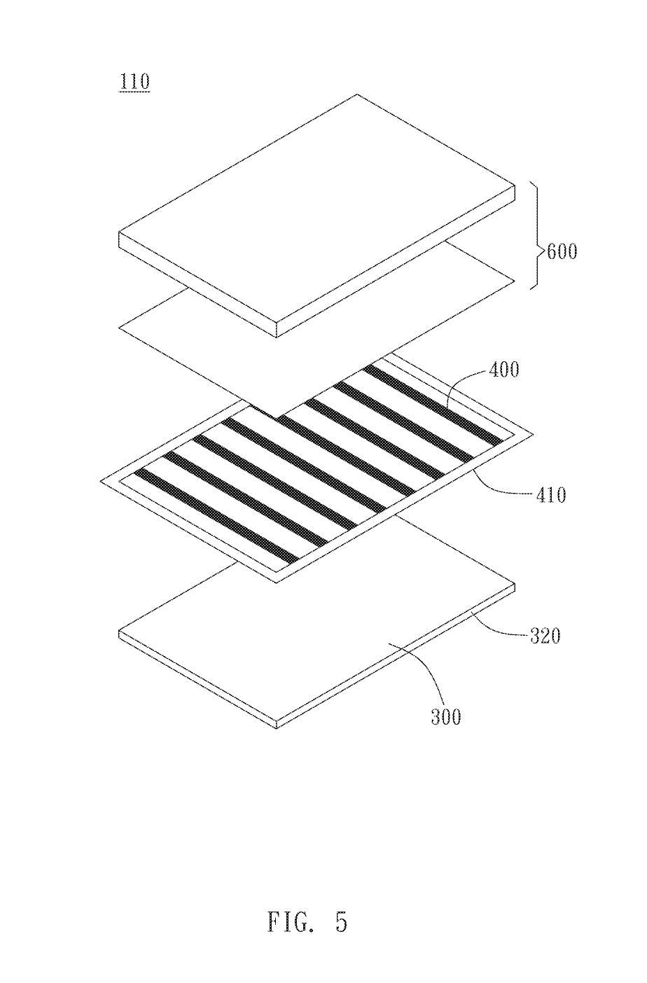

FIG. 4 is a schematic view of a local stereo image display system 100. As shown in FIG. 4, the local stereo image display system 100 includes a signal processing module 500, an optical grating switching controller 420, and an image display device 310. The image display device 310 may display images according to the local stereo image display signal stream. The signal processing module 500 outputs the local stereo image display signal stream from the frame outputting unit 504 to the image display device 310. Please referring to the schematic view of FIG. 1, the local stereo image display signal stream includes the planar image frame 202 and the stereo image frame 204. The planar image frame 202 and the stereo image frame 204 that is disposed between two adjacent planar image frames 202 are alternatively displayed with a display frequency larger than or equal to 120 Hz. In the planar image frame 202, the image only exists in the planar image region 301, and in the stereo image frame 204, the image only exists in the stereo image region 302. Besides, the optical grating switching controller 420 outputs an optical grating control signal (t) to the optical grating device 410. The optical grating device 410 is disposed corresponding to the display area 300 of the image display device 310. As mentioned in FIG. 3, the plurality of optical gratings is disposed at the display side of the display area 300. The optical grating control signal (t) is simultaneously outputted along with a sequence of the planar image frame 202 and the stereo image frame 204 to alternatively switch optical gratings to an active mode or an inactive mode. The optical grating control signal (t) is outputted to the optical grating device 410 to turn off the optical gratings when the optical grating switching controller 420 detects that the planar image frame is outputted. The optical grating control signal (t) is outputted to the optical grating device 410 to turn on the optical gratings when the optical grating switching controller 420 detects that the stereo image frame is outputted. Therefore, the switching speed of the optical gratings must match the display frequency of outputting the planar image frame 202 and the stereo image frame 204. When the planar image frame 202 is outputted, the optical grating control signal (t) is provided to turn off the optical gratings so as to display the planar image region 301. When the stereo image frame 204 is outputted, the optical grating control signal (t) is provided to turn on the optical gratings so as to display the stereo image region 302. The physical assembly of the local stereo image display system mentioned in FIG. 4 can refer to FIG. 5. FIG. 5 is a schematic view of a local stereo image display device 110. As shown in FIG. 5, the local stereo image display device 110 includes a display panel 320, the optical grating device 410 and the touch interface 600. The method of displaying image in the display area 300 by the local stereo image display signal stream can refer to the above descriptions and will not elaborate hereinafter.

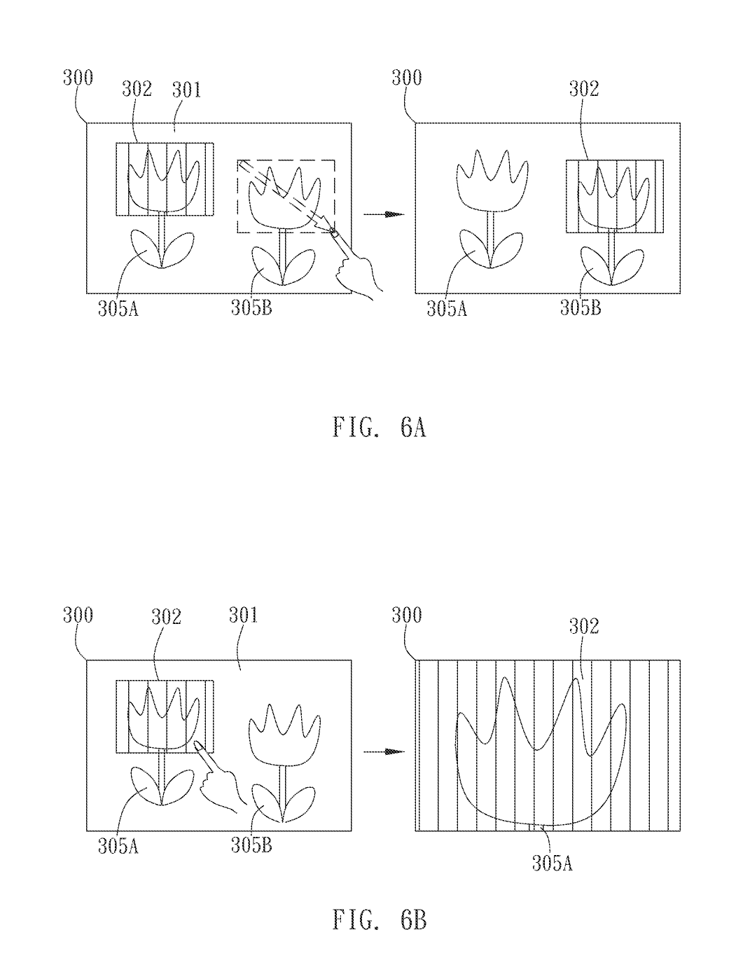

Besides, as shown in FIG. 4, the signal processing module 500 further includes a touch receiving unit 502 to receive a command from the touch interface 600, with reference to the description of FIG. 6A and FIG. 6B. FIG. 6A is a schematic view of an embodiment of changing a specific area into a stereo image. As shown in FIG. 6A, user can see the local stereo image of an object 305A, a part of the planar image of the object 305A, and the planar image of an object 305B. At this time, the user touches the screen with his/her finger or stylus and drags for a distance, and the touch interface 600 will select a specific area (the frame in dashed line as shown in FIG. 6A) based on the dragging distance and outputs a signal to the frame outputting unit 504 through the touch receiving unit 502. The frame outputting unit 504 cancels the planar image region 301 of the planar image frame 202 within the dashed line frame according to the user's operation and generates the stereo image region 302 in the stereo frame 302 corresponding to the location of the dashed line frame to achieve the alteration of the location of the stereo image region 302, as shown in the right of FIG. 6A. This embodiment is an example of operating the touch screen, but not limited thereto. The user may utilize a device such as a tracking pad to achieve the operation mentioned above. Besides, the user can switch the method of adjusting locations based on requirements. For example, the operation of the user may be defined as “generating the planar image in the dragging area”, and then the frame outputting unit 504 will generate the planar image region 301 in the specific area of the planar image frame 202 according to the user's operation and cancel the stereo image region 302 corresponding to the specific area in the stereo image frame 204.

FIG. 6B is a schematic view of an embodiment of enlarging a specific area. As shown in FIG. 6B, the user can see the local stereo image of an object 305A, a part of the planar image of the object 305A, and the planar image of an object 305B. At this time, the user touches the stereo image region 302 by a gesture (such as double click), and the touch interface 600 will output the signal to the frame outputting unit 504 through the touch receiving unit 502 to enlarge the stereo image region 302 in full screen. That is, the planar image frame 202 is a black image and the stereo image frame 204 has the stereo image region 302 which is enlarged into full screen at the touch location, so that the user can watch a stereo visual effect in full screen. Besides, a magnification ratio may be preset in the frame outputting unit 504. When the user double-clicks the stereo image region 302 once, the stereo image region 302 of the stereo image frame 204 is enlarged into two-times by the frame outputting unit 504, and the planar image region 301 of the planar image frame 202 is accordingly narrowed. When the user double clicks the two-times enlarged stereo image region 302 again, the stereo image region 302 of the stereo image frame 204 is enlarged into four-times by the frame outputting unit 504, and the planar image region 301 of the planar image frame 202 is further narrowed. By this design, the frame outputting unit 504 can adjust the location of the outputting image regions and change the outputting content of the local stereo image by the touch interface 600.

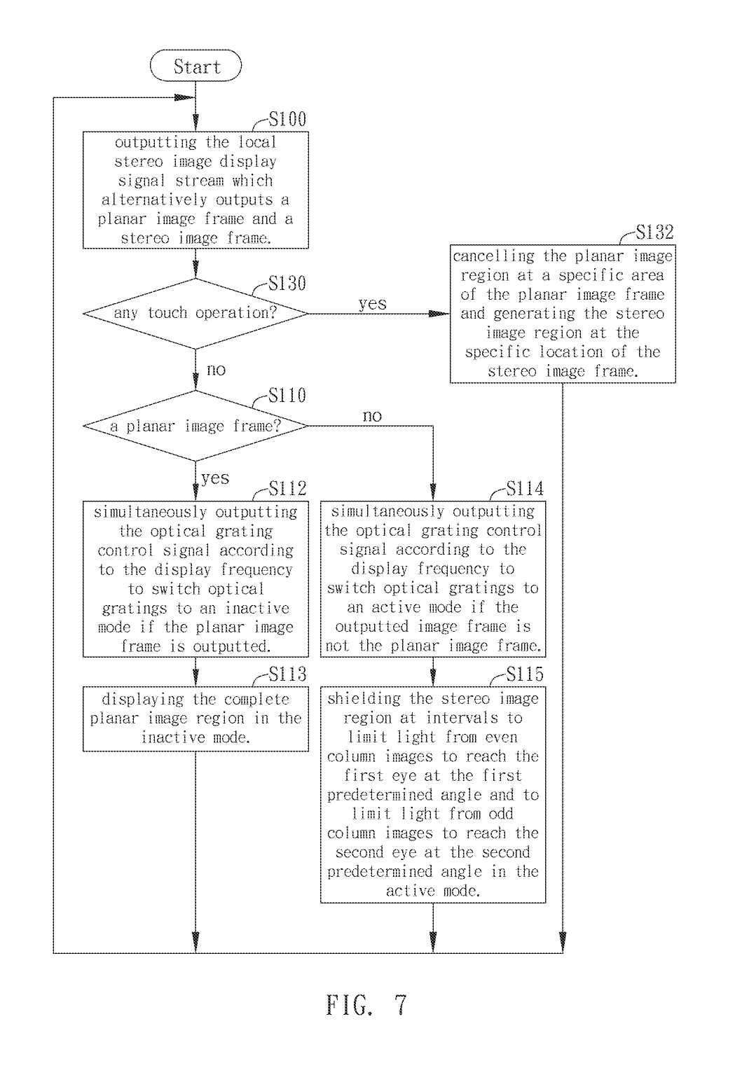

FIG. 7 is a flowchart of a local stereo image display method. As shown in FIG. 7, the local stereo image display method includes the following steps. Step S100 includes outputting the local stereo image display signal stream which alternatively outputs a planar image frame and a stereo image frame. Step S110 involves determining whether the planar image frame is outputted? Sep S112 includes simultaneously outputting the optical grating control signal according to the display frequency to switch optical gratings to an inactive mode if the planar image frame is outputted. Step S113 includes displaying the complete planar image region in the inactive mode. Step S114 involves simultaneously outputting the optical grating control signal according to the display frequency to switch optical gratings to an active mode if the outputted image frame is not the planar image frame. Step S115 includes shielding the stereo image region at intervals to limit light from even column images to reach the first eye at the first predetermined angle and to limit light from odd column images to reach the second eye at the second predetermined angle in the active mode.

As to the method of adjusting the local stereo image, referring to the description of FIG. 4 and FIG. 6A, the touch interface 600 outputs the signal to the frame outputting unit 504 by the touch receiving unit 502 to achieve the position adjustment of the stereo image region 302 when the user changes display state by means of touch. As such, if there is an external operation occurred after the step S100, determination steps may be added as follows: step S130 involves determining whether any external operations are performed on the display area? If there is an external operation, then goes to the step S132, cancelling the planar image region at a specific area of the planar image frame and generating the stereo image region at the specific location of the stereo image frame. If there is no external operation, then goes to the aforementioned step S110 to switch on/off states of optical gratings by the display frequency to display the local stereo image. It is noted that the adjusting method of step S132 is not limited to the method as shown in FIG. 7. Taking the aforementioned embodiment of “generating the planar image in the dragging region” as an example, step S132 may be changed as: generating the planar image region at a specific area of the planar image frame and cancelling the stereo image region at the specific area of the stereo image frame. As to the embodiment of the narrowing and enlarging method mentioned in FIG. 6B, step S132 may be changed as: enlarging the stereo image region at a specific area of the stereo image frame with a ratio and accordingly narrowing the planar image region at the specific area of the planar image frame. By this design, the outputting content of the stereo image may combine with the touch operation to change the location of local outputting image regions.

Although the preferred embodiments of present invention have been described herein, the above description is merely illustrative. The preferred embodiments disclosed will not limit the scope of the present invention. Further modification of the invention herein disclosed will occur to those skilled in the respective arts and all such modifications are deemed to be within the scope of the invention as defined by the appended claims.

What is claimed is:

1. A local stereo image display system, comprising:
an image display device having a display area;
an optical grating device disposed corresponding to the display area of the image display device;
an optical grating switching controller outputting an optical grating control signal to the optical grating device; and
a signal processing module including a frame outputting unit outputting a local stereo image display signal stream to the image display device.

2. The local stereo image display system of claim 1, further comprising a touch interface outputting a command.

3. The local stereo image display system of claim 2, wherein the signal processing module further comprises a touch receiving unit for receiving the command.

4. The local stereo image display system of claim 2, wherein the local stereo image display signal stream comprises a planar image frame and a stereo image frame.

5. The local stereo image display system of claim 4, wherein the planar image frame enables the display area to have a planar image region and a first black image region.

6. The local stereo image display system of claim 5, wherein the stereo image frame enables the display area to have a second black image region and a stereo image region.

7. The local stereo image display system of claim 6, wherein the second black image region corresponds to the planar image region.

8. The local stereo image display system of claim 6, wherein the stereo image region corresponds to the first black image region.

9. A local stereo image display method comprising:
outputting a planar image frame to an image display device and an optical grating switching controller;
the optical grating switching controller outputting an optical grating control signal to an optical grating device to turn off a plurality of optical gratings;
outputting a stereo image frame to the image display device and the optical grating switching controller; and
the optical grating switching controller outputting another optical grating control signal to the optical grating device to turn on the plurality of optical gratings.

10. The local stereo image display method of claim 9, wherein the image display device displays a screen image having a planar image region and a black image having a first black image region when the plurality of optical gratings are turned off.

11. The local stereo image display method of claim 9, wherein the image display device displays a screen image having a stereo image region and a black image having a second black image region when the plurality of optical gratings are turned on.

12. The local stereo image display method of claim 11, wherein the screen image having the stereo image region comprises a plurality of odd column images and a plurality of even column images interlaced to each other.

13. The local stereo image display method of claim 9, wherein the planar image frame and the stereo image frame are outputted orderly with a frequency larger than or equal to 120 Hz.

14. The local stereo image display method of claim 9, wherein the optical grating device is turned on and off orderly with a frequency larger than or equal to 120 Hz.

15. A local stereo image adjusting method, comprising:
outputting a signal to a frame outputting unit;
the frame outputting unit adjusting a planar image region; and
the image frame outputting unit adjusting a stereo image region.

16. The local stereo image adjusting method of claim 15, further comprising:
providing a touch interface;
the touch interface outputting a command to a touch receiving unit; and
the touch receiving unit outputting the signal.

17. The local stereo image adjusting method of claim 15, wherein the touch interface is a touch screen or a track pad.

18. The local stereo image adjusting method of claim 15, wherein the step of adjusting the planar image region includes cancelling, generating, enlarging, or narrowing the planar image region or changing a position of the planar image region.

19. The local stereo image adjusting method of claim 15, wherein the step of adjusting the stereo image region includes cancelling, generating, enlarging, or narrowing the planar image region or changing a position of the stereo image region.

20. The local stereo image adjusting method of claim 15, further comprising:
the frame outputting unit alternatively outputting a planar image frame and a stereo image frame to an image display device and an optical grating switching controller; and
the optical grating switching controller outputting an optical grating control signal to an optical grating device and simultaneously turning on and off the optical grating device alternatively.
